(19) United States
(12) Patent Application Publication
(10) Pub. No.: US 2014/0352873 A1
(43) Pub. Date: Dec. 4, 2014

(54) WINDING METHOD FOR THE PRODUCTION OF A ROTATIONALLY SYMMETRIC, TUBE-LIKE HOLLOW BODY PREFORM, DEVICE AND METHOD FOR THE PRODUCTION OF A DEVICE FOR PRODUCING THE SAME

(71) Applicant: Robert Bosch GmbH, Stuttgart (DE)

(72) Inventors: Ingo Bork, Lohr (DE); Thomas Seufert, Steinfeld (DE)

(21) Appl. No.: 14/365,911

(22) PCT Filed: Dec. 13, 2012
(86) PCT No.: PCT/EP2012/075392

§ 371 Date: Jun. 16, 2014

(30) Foreign Application Priority Data
Dec. 16, 2011 (DE) 10 2011 121 987.4

(51) Int. Cl. B29D 23/00

(52) U.S. Cl. CPC B29D 23/00; B29L 2023/00
USPC 156/156; 156/169; 156/475

(57) ABSTRACT

Winding method for the production of a rotationally symmetric, tube-like hollow body preform, device (10) for the production of a rotationally symmetric, tube-like hollow body preform and a method for the production of a device for producing a rotationally symmetric, tube-like hollow body preform, wherein reinforcing fibres soaked with a resin are wound in a winding process on a rotatably driven winding core (1) having an outside diameter corresponding to the inside diameter of the hollow body preform and wherein the hollow body preform is removed from the winding core after a subsequent hardening of the hollow body preform by means of supplied heat. For the winding process and/or hardening of the hollow body preform, the outside diameter of the winding core corresponds to the inside diameter of the hollow body preform to be produced, wherein the outside diameter of the winding core is reduced to a smaller outside diameter for the removal of the hollow body preform from the winding core.

### BACKGROUND OF THE INVENTION

The invention relates to a winding method for producing a rotationally symmetrical tube-like hollow-body preform, a device for producing a rotationally symmetrical tube-like hollow-body preform, and a method for producing a device for producing a rotationally symmetrical tube-like hollow-body preform, wherein reinforcing fibers impregnated with a resin are wound, in a winding operation, onto a rotatably driven winding core of which the outer diameter corresponds to the inner diameter of the hollow-body preform and wherein, after subsequent curing of the hollow-body preform by means of supplied heat, the hollow-body preform is removed from the winding core.

In the case of winding methods of this type an inner diameter of the hollow-body preform automatically arises following curing of the hollow-body preform. Said inner diameter is directly influenced by the curing temperature, the construction of the laminate of the hollow-body preform, thermal expansion of the winding core, fiber material and matrix material, matrix contraction, etc. This has the effect that an inner diameter of the hollow-body preform cannot be produced at all to be within tight tolerances (e.g. H6) or only with great difficulties. Depending on circumstances, specific adaptation of the winding core has to be repeated after every change in, for example, the construction of the laminate, the fiber material and matrix material, or the curing cycle.

It is thus the object of the invention to provide a winding method for producing a rotationally symmetrical tube-like hollow-body preform, a device for producing a rotationally symmetrical tube-like hollow-body preform, and a method for producing a device for producing a rotationally symmetrical tube-like hollow-body preform by way of which hollow-body preforms which can be reproducibly crafted with an inner diameter at a high limit of accuracy are producible in a simple manner.

### SUMMARY OF THE INVENTION

This object is achieved in a winding method for producing a rotationally symmetrical tube-like hollow-body preform, wherein reinforcing fibers impregnated with a resin are wound, in a winding operation, onto a rotatably driven winding core of which the outer diameter corresponds to the inner diameter of the hollow-body preform and wherein, after subsequent curing of the hollow-body preform by means of supplied heat, the hollow-body preform is removed from the winding core, in that, for the winding operation and/or for curing the hollow-body preform, the outer diameter of the winding core has an outer diameter which corresponds to the inner diameter of the hollow-body preform to be produced and which, for removing the hollow-body preform from the winding core, is reduced to a smaller outer diameter.

On account of this method, demolding after curing is a simple and reliable process.

Since the risk of damage to the outer surface of the winding core is low, the risk of damage to the inner surface of the hollow body is also low, such that hollow bodies can be reproducibly crafted within tight tolerances, such as, for example, H6.

Moreover, a long service life of the winding core is achieved, on account of which downtimes for replacing the winding core are greatly reduced.

If, for the winding operation, the winding core has the smaller outer diameter and, for curing, is enlarged so as to have the outer diameter which corresponds to the inner diameter of the hollow-body preform to be produced, the reinforcing fibers are tensioned after the winding operation and prior to curing, such that a favorable inherent tension is introduced for a downstream interior-pressure load of the hollow-body preform.

If, in the course of the method, the outer diameter which corresponds to the inner diameter of the hollow-body preform to be produced is regulated so as to be a specific outer diameter, thermal expansion of the in particular metallic winding core when heat is applied during curing can be considered, for example.

This may take place, for example, depending on a specific widening force characteristic for enlarging the outer diameter of the winding core, which correlates to the curing temperature.

By way of widening the outer diameter of the winding core, the inner diameter of the hollow-body preform can be set precisely, said inner diameter being somewhat larger than the thermal expansion of the winding core that is to be expected.

After curing and cooling a gap is created between the winding core and the hollow-body preform, which can be utilized to simplify demolding.

The gap being created is typically larger than in a conventional demolding process, so that demolding becomes a significantly more simple and reliable process, the service life of the winding core is extended and the risk of damage to the inner surface of the hollow-body preform is lower.

If a container or a hydraulic accumulator or a hydraulic cylinder or a tube is produced by way of the winding method, these components will display a low weight paired with a high load capacity. Therefore, they may be advantageously employed in the field of mobile hydraulics, as accumulators for vehicles having a hydraulic drive and for hydraulic hybrid vehicles.

With respect to a device for producing a rotationally symmetrical tube-like hollow-body preform, having a rotatably drivable winding core onto the central region of which, in a winding operation, reinforcing fibers impregnated with resin can be wound to form a hollow-body preform, the object is achieved in that, in the region to be wrapped by the reinforcing fibers, the winding core is configured as a tube-like hollow body which has an elastically deformable wall and the interior of which is filled with a hydraulic fluid and, by way of application of a specific pressure, is expandable in its outer diameter from a smaller outer diameter to an outer diameter which corresponds to the inner diameter of the hollow-body preform to be produced.

Therefore, by applying pressure or releasing pressure, respectively, enlarging or reducing, respectively, of the outer diameter of the winding core may take place in a simple manner, on account of which the aforementioned winding method can be carried out by the device and its advantages may be achieved.

By way of regulating the pressure in the interior of the tube-like hollow body of the winding core, which is filled with hydraulic fluid, the outer diameter of the winding core, despite its thermal expansion, can be kept constant during the thermal treatment when curing and a high tolerance of the inner diameter of the hollow-body preform can be reproducibly adhered to in this manner.

For supplying pressure, the winding core may have a supply line which leads from the outside to the interior of the tube-like hollow body and by way of which pressure can be applied to the interior of the tube-like hollow body, the supply line preferably extending coaxially through the winding core.

In one advantageous embodiment the winding core has two winding journals which are coaxially disposed in a spaced-apart manner to one another, wherein the distance between the winding journals is enclosed by a winding tube which forms the region to be wrapped and which, with its axial ends, is fixedly and tightly connected to the mutually facing axial ends of the winding journals, and the interior of which forms the interior which is filled with hydraulic fluid.

However, the winding core may also have a winding journal in one part which is enclosed at a radial distance by a winding tube which forms the region to be wrapped, wherein the annular space between the winding journal and the winding tube, which is formed by the radial distance, forms the interior which is filled with hydraulic fluid.

For ready demoldability the winding tube advantageously has a larger outer diameter than the regions of the winding journal or winding journals that are axially adjacent thereto.

The object is achieved for a method for producing a device for producing a rotationally symmetrical tube-like hollow-body preform, having a rotatably drivable winding core onto the central region of which, in a winding operation, reinforcing fibers impregnated with resin can be wound to form a hollow-body preform and which in its region to be wrapped by the reinforcing fibers, is configured as a tube-like hollow body which has an elastically deformable wall and the interior of which is filled with a hydraulic fluid and, by way of application of a specific pressure, is expandable in its outer diameter from a smaller outer diameter to an outer diameter which corresponds to the inner diameter of the hollow-body preform to be produced, in that a specific pressure is applied to the interior of the hollow body and, on account thereof, by elastic deformation of its elastically deformable wall, the outer diameter of the region to be wrapped of the tube-like hollow body is expanded from a smaller outer diameter than the inner diameter of the hollow-body preform to be produced to a larger outer diameter than the inner diameter of the hollow-body preform to be produced and that, while maintaining the application of pressure, the radially encircling sleeve area of the tube-like hollow body is reduced by way of material subtraction to an outer diameter which corresponds to the inner diameter of the hollow-body preform to be produced.

In this way, the winding core receives its larger outer diameter which defines the inner diameter of the hollow-body preform under conditions which correspond to real operational conditions and, therefore, with a high degree of dimensional accuracy.

When used in production, only a precise application of the specific pressure has to take place for the elastically deformable wall of the winding core to be widened with a high degree of dimensional accuracy to the larger outer diameter.

### BRIEF DESCRIPTION OF THE DRAWINGS

Exemplary embodiments of the invention are illustrated in the drawing and are described in more detail in the following. In the drawing:

FIG. 1 shows a first exemplary embodiment of a winding core in the longitudinal section, having a schematic illustration of a pressure-supply installation, and

FIG. 2 shows a second exemplary embodiment of a winding core in the

### DETAILED DESCRIPTION

The winding cores 1, 1′ illustrated in the figures are part of a winding device for carrying out a winding method for producing hollow-body preforms as fiber-composite components.

In this method reinforcing fibers impregnated with a resin, in particular a plastic resin, are wound onto the winding core which is rotatably driven about a rotation axis 8.

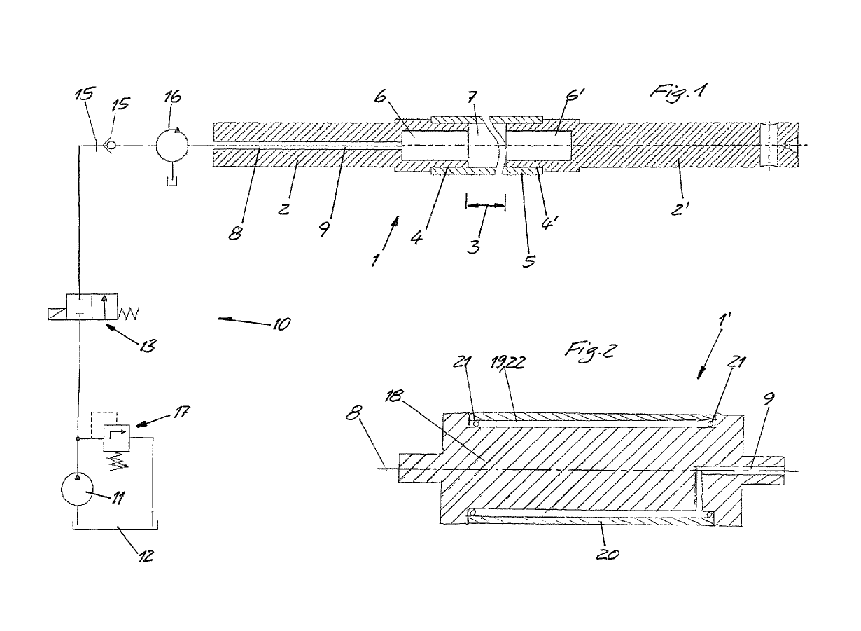

The winding core 1 illustrated in FIG. 1 has two winding journals 2, 2′ which are coaxially disposed to one another at a distance 3.

On the radially encircling sleeve areas of the mutually facing end regions of the winding journals 2, 2′ radially encircling grooves 4, 4′, which are open towards the mutually facing free ends, are configured.

Bridging the distance 3, a winding tube 5 which is associated with the winding core 1 is tightly inserted into the grooves 4, 4′, the outer diameter of the winding tube being larger than the outer diameter of the winding journals 2, 2′.

Commencing from the mutually facing end faces, coaxial blind bores 6, 6′ which, together with the distance 3 which is enclosed by the winding tube 5, form an interior 7 which is filled with a hydraulic fluid are configured in the winding journals 2, 2′.

Entering from the outer end face, a supply line 9, which leads to the interior 7, is coaxially configured in the winding journal 2.

A pressure-supply installation 10 has a hydraulic pump 11 which draws hydraulic fluid from a container 12 and, via an electrically actuatable 2/2-way valve 13, a hydraulic rapid coupling 15 having a nonreturn valve 14, and a hydraulic rotary feedthrough 16, leads to and is connected to that end of the supply line 9 that opens to the outside.

On that section of the supply line 9 that leads from the hydraulic pump 11 to the 2/2-way valve 13 an electric pressure control valve 17 is connected.

The hydraulic pressure which is applied to the interior 7 and which may be of the order of magnitude of 200 bar for example, when made available by the 2/2-way valve 13, is provided by the hydraulic pump 11 and set by the pressure control valve 17. The pressure control valve 17 and, therefore, the pressure which is applied to the interior 7 may either be ran according to a pressure characteristic which is stored in an electronics unit (not illustrated) and which correlates to the curing temperature, or the curing temperature may be directly used as the guiding variable of control by the pressure control valve 7.

The hydraulic rapid coupling 15 serves to disconnect the winding core 1 from the pressure supply, even when possibly under internal pressure.

The winding core 1′ illustrated in FIG. 2 has a schematically illustrated rotationally symmetrical winding journal 18 which, in reality, consists of multiple parts and which, in its region to be wrapped by the reinforcing fibers, has a radially encircling annular groove 19 which, at a radial distance, is enclosed by a winding tube 20 which is associated with the winding core 1′.

On its axial ends, the winding tube 20 is sealed by way of seals 21 with respect to the base of the annular groove 19, on account of which an annular space 22 which is sealed with respect to the outside and is filled with a hydraulic fluid is formed between the base of the annular groove 19 and the winding tube 20.

From one end face of the winding journal 18 a supply line 9, which can be connected to a pressure-supply installation 10 according to FIG. 1 or to a pressure-supply installation which is constructed in a different manner, leads to the annular space 22.

According to FIG. 1 the annular space 22 can have pressure applied to it by way of the pressure-supply installation and, on account thereof, the outer diameter of the winding tube 20 is elastically expandable from a reduced outer diameter to a larger outer diameter which corresponds to the inner diameter of the hollow-body preform to be produced and can also be correspondingly regulated, according to FIG. 1, dependent on the curing temperature.

1. A winding method for producing a rotationally symmetrical tube-like hollow-body preform, wherein reinforcing fibers impregnated with a resin are wound, in a winding operation, onto a rotatably driven winding core of which an outer diameter corresponds to an inner diameter of the hollow-body preform and wherein, after subsequent curing of the hollow-body preform by means of supplied heat, the hollow-body preform is removed from the winding core, characterized in that, for at least one of the winding operation and the curing of the hollow-body preform, the outer diameter of the winding core (1, 1′) has the outer diameter which corresponds to the inner diameter of the hollow-body preform to be produced and wherein, for removing the hollow-body preform from the winding core (1, 1′), the outer diameter is reduced to a smaller outer diameter.

2. The winding method as claimed in claim 1, characterized in that, for the winding operation, the winding core (1, 1′) has the smaller outer diameter and, for curing, the winding core is enlarged so as to have the outer diameter which corresponds to the inner diameter of the hollow-body preform to be produced.

3. The winding method as claimed in claim 1, characterized in that, in the course of the method, the outer diameter which corresponds to the inner diameter of the hollow-body preform to be produced is regulated so as to be a specific outer diameter.

4. The winding method as claimed in claim 1, characterized in that a container or a hydraulic accumulator or a hydraulic cylinder or a tube is produced by way of the winding method.

5. A device for producing a rotationally symmetrical tube-like hollow-body preform, the device having a rotatably drivable winding core onto a central region of which, in a winding operation, reinforcing fibers impregnated with resin can be wound to form the hollow-body preform, characterized in that, in the region to be wrapped by the reinforcing fibers, the winding core (1, 1′) is configured as a tube-like hollow body which has an elastically deformable wall and an interior (7, 22) of which is filled with a hydraulic fluid and, by way of application of a specific pressure, is expandable from a smaller outer diameter to an outer diameter which corresponds to an inner diameter of the hollow-body preform to be produced.

6. The device as claimed in claim 5, characterized in that the winding core (1, 1′) has a supply line (9) which leads from an outside to the interior (7, 22) of the tube-like hollow body and by way of which pressure can be applied to the interior (7, 22) of the tube-like hollow body.

7. The device as claimed in claim 5, characterized in that the winding core (1) has two winding journals (2, 2′) which are coaxially disposed in a spaced-apart manner to one another, wherein a distance (3) between the winding journals (2, 2′) is enclosed by a winding tube (5) which forms the region to be wrapped and which, with its axial ends, is fixedly and tightly connected to mutually facing axial ends of the winding journals (2, 2′), and an interior (7) of which forms the interior (7) which is filled with hydraulic fluid.

8. The device as claimed in claim 5, characterized in that the winding core (1′) has a winding journal (18) which is enclosed at a radial distance by a winding tube (20) which forms the region to be wrapped, wherein an annular space (22) between the winding journal (18) and the winding tube (20), which is formed by the radial distance, forms the interior which is filled with hydraulic fluid.

9. The device as claimed in claim 5, characterized in that the winding tube (5, 20) has a larger outer diameter than regions of the winding journal or winding journals (2, 2′; 18) that are axially adjacent thereto.

10. A method for producing a device for producing a rotationally symmetrical tube-like hollow-body preform, having a rotatably drivable winding core onto a central region of which, in a winding operation, reinforcing fibers impregnated with resin can be wound to form a hollow-body preform and which, in the region to be wrapped by the reinforcing fibers, is configured as a tube-like hollow body which has an elastically deformable wall and an interior of which is filled with a hydraulic fluid and, by way of application of a specific pressure, is expandable from a smaller outer diameter to an outer diameter which corresponds to an inner diameter of the hollow-body preform to be produced, characterized in that a specific pressure is applied to the interior (7, 22) of the hollow body and, on account thereof, by elastic deformation of its elastically deformable wall, the outer diameter of the region to be wrapped of the tube-like hollow body is expanded from a smaller outer diameter than the inner diameter of the hollow-body preform to be produced to a larger outer diameter than the inner diameter of the hollow-body preform to be produced and that, while maintaining the application of pressure, a radially encircling sleeve area of the tube-like hollow body is reduced by way of material subtraction to an outer diameter which corresponds to the inner diameter of the hollow-body preform to be produced.
